(19) United States
(12) Patent Application Publication
(10) Pub. No.: US 2008/0046822 A1
(43) Pub. Date: Feb. 21, 2008

(54) Apparatus and method for interactive user software interface design

(76) Inventor: Frank Meyer, Milford, MI (US)

Correspondence Address: YOUNG & BASILE, P.C., 3001 WEST BIG BEAVER ROAD, SUITE 624, TROY, MI, 48084, US

(21) Appl. No.: 11/504,357

(22) Filed: Aug. 15, 2006

(51) Int. Cl. G06F 9/00

(52) U.S. Cl. 715/730; 715/732; 715/762

(57) ABSTRACT

An interface allows objects of a property page of a graphical user interface to be edited without requiring input by the user of software code. The interface converts user generated object edits to a form which is executable by an application program.

### BACKGROUND

The present invention relates, in general, to data processing systems and, also, to methods and apparatus for displaying graphical information on a computer system and, also, to electronic presentation software.

Many software systems create a windowing environment that manages interactions between a user and an application program executing on a computer through a graphical display monitor. Each sheet of information is displayed on the monitor in a rectangular region of the screen called a “window.”

In a typical window-based Graphical User Interface System, such as Microsoft Windows®, a variety of techniques are provided to the operator to manage the windows on the display. Typically, two levels of interaction are provided for the user. The first is a main application interface that is presented to the user. The second is known as “property pages” or “dialog boxes”, which are individual windows that are launched by the software that allow the user to define parameters that set how the application program is to run. Dialog boxes are often used to determine the location where a file will be saved to or loaded from. While the property pages allow the user to manipulate various aspects of the software, the property pages or dialog boxes themselves cannot be changed or edited by the user.

In today's market, several presentation software packages are available which are designed to allow users to set up a sequence of slides containing text and images that can be displayed to an audience using a projector or similar output device. Most presentation software programs are designed to allow the user to place text and/or images anywhere on the screen. Examples of such presentation software include Microsoft PowerPoint, and Presentation Manager by Creative Lifestyles, Inc., Milford, Mich. 48380.

It would be desirable to provide a method and an apparatus for a user to edit or change any property of a property page or dialog box without the user having to generate any software program code. It would also be desirable to provide a means for a user to arrange and manipulate the look and functionality of property and dialog pages.

### SUMMARY

A method of controlling content on a property page of a graphical user interface comprising the steps of providing property I.D.'s of at least one object on a property page; creating a file describing how the properties are to be displayed, the file containing the property I.D.'s; linking the file to the object being edited and allowing properties of at least one property of the object to be edited; and converting the edited object property values to code executable by an application program.

In the method, the step of creating the file further comprises the step of creating the file as an xml file.

In the method, the step of creating the file further comprises the step of creating the file as a slide containing a list of display/edit entities, each entity referencing a proper I.D. of an object.

In the method, the step of linking the file to the object further comprises the step of using a presentation application program to link the slide to the object being edited.

The unique interface described herein enables a user to edit objects on a property page of a graphical user interface as to the location, function, background image, color, shape, etc., without having to generate an input software code to the application program. The user merely generates edit commands to the properties of the object, which commands are converted by the interface to a form which is executable by the application program.

### BRIEF DESCRIPTION OF THE DRAWINGS

The various features, advantages and other uses of the present invention will become more apparent by referring to the following detailed description and drawing in which:

FIG. 1 is a pictorial representation of an electronic presentation system and a computer processor for presenting a series of electronic slides;

FIG. 2 is a block diagram showing the bridge interface between the user and a property page;

FIG. 3 is a block diagram showing an interface between an object and its properties on a property page;

FIG. 4 is a block diagram showing an implementation using a presentation manager; and

FIG. 5 is a pictorial representation of an existing property page and a modified property page using the bridge or interface shown in FIG. 1.

### DETAILED DESCRIPTION

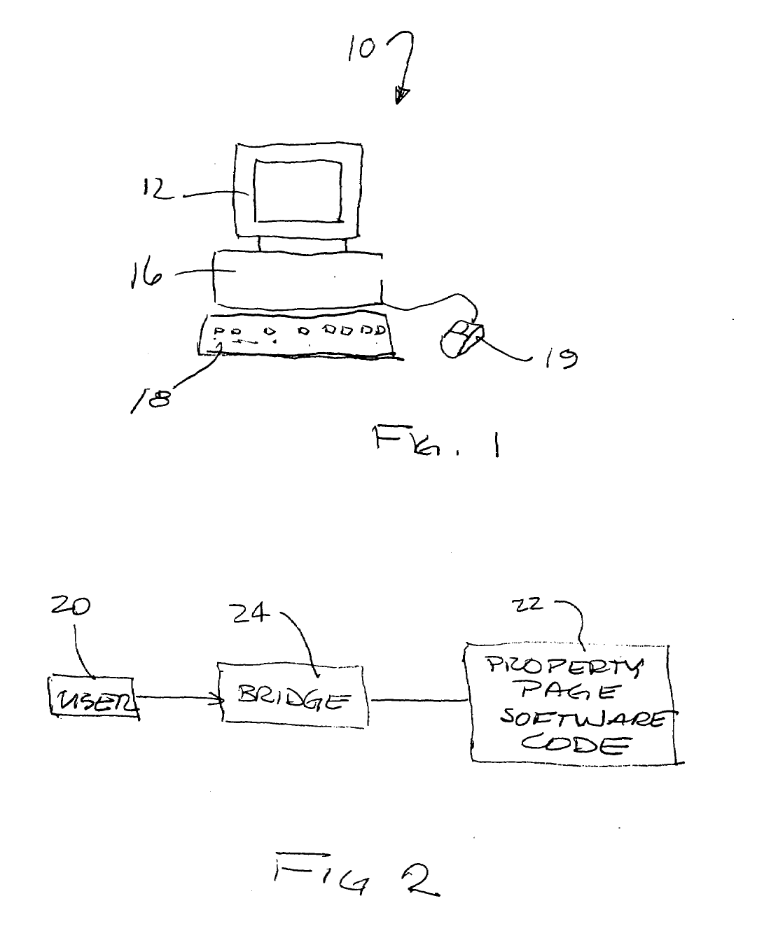

Referring now to the drawing, and to FIG. 1 in particular, there is depicted, for example, a typical electronic presentation apparatus 10. The electronic presentation apparatus 10 includes a computer processor or work station 16 which may be a stand-alone computer, or a special-purpose processor, a keyboard 18 and an optional mouse 19.

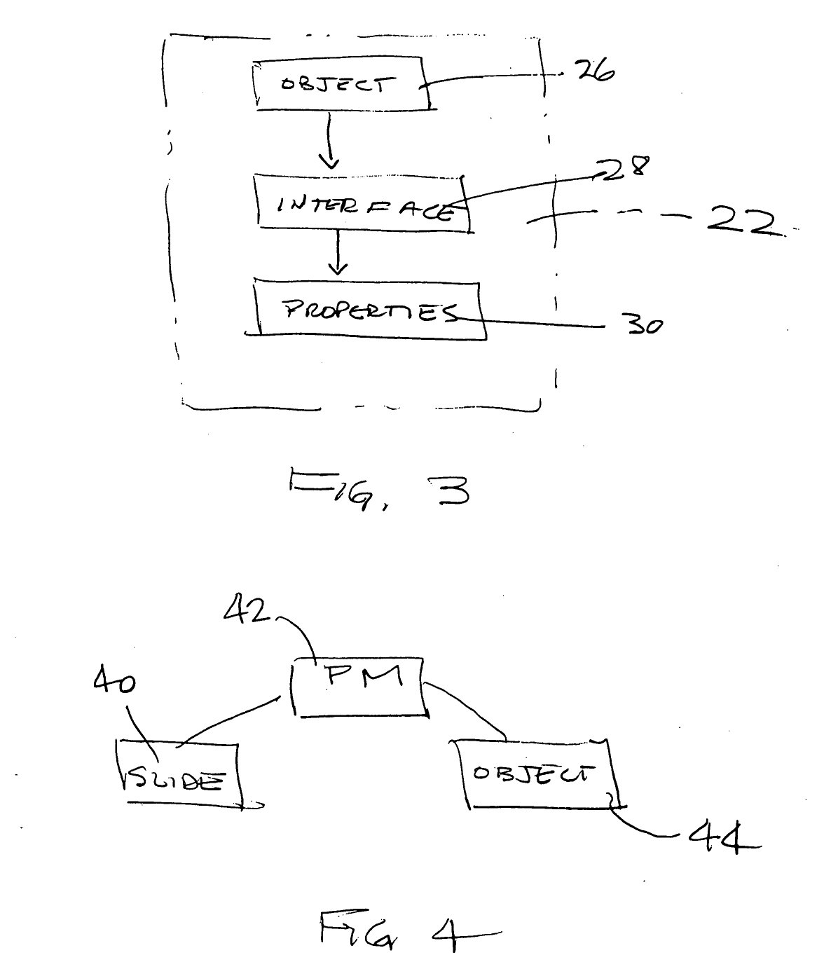

In the present software interface, the dialog box and/or property pages, both hereafter referred to as “property pages,” are not hard coded within the operating system software code, but rather are made a part of the user interface. As shown in FIG. 2, this enables a user 20 to access and revise the software code of each property page 22 by means of a bridge or interface 24.

ActiveX for objects has an interface through which properties of that object can be sorted or read. The interface 24 allows access to a number of properties of each object. Each property is referenced by an I.D. Each property can also give the type, i.e., numeric or string or file, etc. Each property can optionally give the minimum and maximum values as applicable or the enumeration of possible values. Each property can optionally report a default value. Each property can optionally give an access level, i.e., all users, advanced user or super user. Each property can also optionally be assigned to a group thereby enabling large numbers of properties to be edited across several pages at the same time.

An application of the present method and apparatus will be demonstrated through the use of a presentation program which allows presentation of a sequence of slides through the presentation device.

Presentation software executed by the processor 10 prepares can be used to an electronic slide for presentation. For example, the slide is saved in an xml file. The xml file is effectively a list of display/edit entities. Each entity references a property ID. Each xml entity further describes the location, and fixed or relative coordinates, the color, and optional background image, any translations, etc. Non-editable entities, such as “images/text”, are also listed to help in the presentation of the slide.

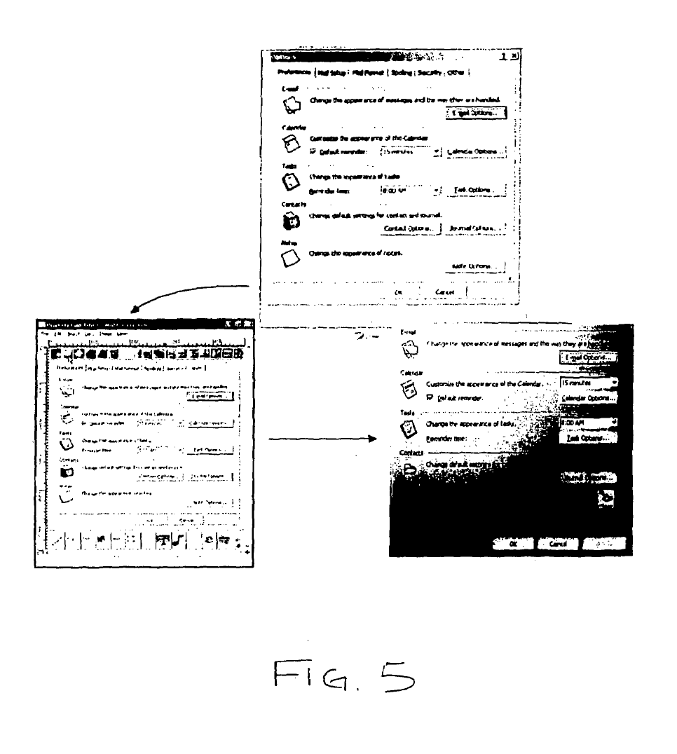

As shown in FIG. 4, the presentation software 42 links a slide 40 to the object 44 being edited. The presentation software 42 presents the object properties to the user. As the user edits the object properties, the edited values are reported back to the object 44 and, if necessary, the slide 40 is re-rendered. In this manner, a user can create or edit property pages for any program, including presentation programs. This allows the user to configure where the editable items are located on the property page, as shown in the pictorial representations in FIG. 5 of an existing property page and an edited property page according to the present apparatus and method, how the editable items are presented, i.e., look, text, etc., and what they do. The original proper page is loaded into a page editor where presentation tools can be used to manipulate the design, color, etc., of the page.

The bridge 24 allows the user to define the name and values that can be modified by the user. The bridge 24 converts what the user creates into working code which is understood by the underlying application software. The bridge 24 may be specific to the application software or be based on an open standard, such as xml, for example.

The changes made by the bridge 24 to the property pages may or may not be automatic. Some of the entries may be automatic and will change within the application the moment the values are changed. Alternately, other entries will not be automatic and will only change in the application once the user confirms the change, typically through an “apply” button.

The property pages will be auto-generated. The software used to edit the property pages will be able to locate all of the editable properties for a given action, i.e., save, load, etc., or parameter, i.e., the complete set of properties for the application, and create a base property page that includes all of the editable properties for the given action or parameter.

The editable properties may be renamed by an alternate source, i.e:, a file. This would enable the property page editor or bridge 24 to be adaptable to many software program languages through a translation file.

What is claimed is:

1. A method of controlling content on a property page of a graphical user interface comprising the steps of:
providing property I.D.'s of at least one object on a property page;
creating a file describing how the properties are to be displayed, the file containing the property I.D.'s;
linking the file to the object being edited and allowing properties of at least one property of the object to be edited; and
converting the edited object property values to code executable by an application program.

2. The method of claim 1 wherein the step of creating the file further comprises the step of:
creating the file as an xml file.

3. The method of claim 1 wherein the step of creating the file further comprises the step of:
creating the file as a slide containing a list of display/edit entities, each entity referencing a proper I.D. of an object.

4. The method of claim 3 wherein the steps of linking the file to the object further comprises the step of:
using a presentation application program to link the slide to the object being edited.
